(19) United States
(12) Patent Application Publication
(10) Pub. No.: US 2008/0201241 A1
(43) Pub. Date: Aug. 21, 2008

(54) Automated coffee system

(76) Inventor: Daniel Ben Pecoraro, San Francisco, CA (US)

Correspondence Address: DAHYEE LAW GROUP, 24301 SOUTHLAND DR., SUITE 405, HAYWARD, CA, 94545, US

(21) Appl. No.: 12/012,265

(22) Filed: Jan. 31, 2008

Related U.S. Application Data
(60) Provisional application No. 60/887,887, filed on Feb. 2, 2007.

(51) Int. Cl. G06Q 30/00; G06F 3/048

(52) U.S. Cl. 705/27; 715/765

(57) ABSTRACT

The invention provides a system in which a user may make a personalized recipe for food or beverage such as coffee and place an order online. A central server processes the order and redirects the recipe, timetable and a reference number associated with the order to a local service station designated by the user. The local service station prepares the ordered product pursuant to the recipe and timetable, and delivers the drink to the customer who enters a correct reference number.

### REFERENCE TO RELATED APPLICATION

The present application claims priority to the provisional Appl. Ser. No. 60/887,887 filed on Feb. 2, 2007, the entire content of which is hereby incorporated by reference.

### FIELD OF THE INVENTION

The present invention relates generally to web-based automated service system. In particular, the invention relates to a unique information technology-based automated coffee service system through which a user may create his personalized recipe by maneuvering a number of visual cues in a user interface supported by a web-based software application, place an order pursuant to the recipe online, and pick up his drink prepared by a machine according to the recipe in a location selected by the user.

### BACKGROUND OF THE INVENTION

Coffee is a widely consumed stimulant beverage prepared from roasted seeds, commonly called beans, of the coffee plant. Coffee was first consumed in the 9th century, when it was discovered in Ethiopia. From there, it spread to Egypt and Yemen, and by the 15th century had reached Persia, Turkey, and northern Africa. From the Muslim world, coffee spread to Italy, then to the rest of Europe and the Americas. Today, coffee is one of the most popular beverages worldwide.

Coffee berries, which contain the coffee bean, are produced by several species of small evergreen bush of the genus Coffea. Once ripe, coffee berries are picked, processed, and dried. The seeds are then roasted, undergoing several physical and chemical changes. They are roasted to various degrees, depending on the desired flavor. They are then ground and brewed to create coffee. Coffee can be prepared and presented by a variety of methods.

Coffee berries and their seeds undergo multi-step processing before they become the roasted coffee. First, coffee berries are picked, generally by hand. Then, the flesh of the berry is removed, usually by machine, and the seeds—usually called beans—are fermented to remove the slimy layer of mucilage still present on the bean. When the fermentation is finished, the beans are washed with large quantities of fresh water to remove the fermentation residue. Finally the seeds are dried and sorted and labeled as green coffee beans.

The next step in the process is the roasting of the green coffee. Coffee is usually sold in a roasted state, and all coffee is roasted before it is consumed. It can be sold roasted by the supplier, or it can be home roasted. The roasting process influences the taste of the beverage by changing the coffee bean both physically and chemically. The bean decreases in weight as moisture is lost but increases in volume, causing it to become less dense. The actual roasting begins when the temperature inside the bean reaches 200° C. (392° F.), though different varieties of beans differ in moisture and density and therefore roast at different rates. During roasting, caramelization occurs as intense heat breaks down starches in the bean, changing them to simple sugars that begin to brown, changing the color of the bean. Sucrose is rapidly lost during the roasting process and may disappear entirely in darker roasts. During roasting, aromatic oils, acids, and caffeine weaken, changing the flavor; at 205° C. (400° F.), other oils start to develop. One of these oils is caffeol, created at about 200° C. (392° F.), which is largely responsible for coffee's aroma and flavor.

Depending on the color of the roasted beans, they will be labeled as light, cinnamon, medium, high, city, full city, French, or Italian roast. Darker roasts are generally smoother, because they have less fiber content and a more sugary flavor. Lighter roasts have more caffeine, resulting in a slight bitterness, and a stronger flavor from aromatic oils and acids destroyed by longer roasting times. A small amount of chaff is produced during roasting from the skin left on the bean after processing. Chaff is usually removed from the beans by air movement, though a small amount is added to dark roast coffees to soak up oils on the beans. Decaffeination may also be part of the processing that coffee seeds undergo. Seeds are decaffeinated when they are still green. Many methods can remove caffeine from coffee, but all involve either soaking beans in hot water or steaming them, then using a solvent to dissolve caffeine-containing oils. Decaffeination is often done by processing companies, and the extracted caffeine is usually sold to the pharmaceutical industry.

Once roasted, coffee beans must be stored properly to preserve the fresh taste of the bean. Ideal conditions are air-tight and cool. Air, moisture, heat and light are the environmental factors in order of importance to preserving flavor in coffee beans.

Coffee beans must be ground and brewed in order to create a beverage. Grinding the roasted coffee beans is done at a roastery, in a grocery store, or in the home. They are most commonly ground at a roastery then packaged and sold to the consumer, though “whole bean” coffee can be ground at home. Coffee beans may be ground in several ways. A burr mill uses revolving elements to crush or tear the bean, an electric grinder chops the beans with blades moving at high speeds, and a mortar and pestle grinds the beans to a powder. The type of grind is often named after the brewing method for which it is generally used. Turkish grind is the finest grind, while coffee percolator or French press is the coarsest grind. The most common grinds are between the extremes; a medium grind is used in most common home coffee brewing machines.

Coffee may be brewed by several methods: boiled, steeped, or pressured. Brewing coffee by boiling was the earliest method, and Turkish coffee is an example of this method. It is prepared by powdering the beans with a mortar and pestle, then adding the powder to water and bringing it to a boil in a pot called a cezve or, in Greek, a briki. This produces a strong coffee with a layer of foam on the surface.

Machines such as percolators or automatic coffeemakers brew coffee by gravity. In an automatic coffeemaker, hot water drips onto coffee grounds held in a coffee filter made of paper or perforated metal, allowing the water to seep through the ground coffee while absorbing its oils and essences. Gravity causes the liquid to pass into a carafe or pot while the used coffee grounds are retained in the filter. In a percolator, boiling water is forced into a chamber above a filter by pressure created by boiling. The water then passes downwards through the grounds due to gravity, repeating the process until shut off by an internal timer.

Coffee may also be brewed by steeping in a device such as a French press (also known as a cafetière). Ground coffee and hot water are combined in a coffee press and left to brew for a few minutes. A plunger is then depressed to separate the coffee grounds, which remain at the bottom of the container. Because the coffee grounds are in direct contact with the water, all the coffee oils remain in the beverage, making it stronger and leaving more sediment than in coffee made by an automatic coffee machine.

The espresso method forces hot, but not boiling, pressurized water through ground coffee. As a result of brewing under high pressure (ideally between 9-10 atm) the espresso beverage is more concentrated (as much as 10 to 15 times the amount of coffee to water as gravity brewing methods can produce) and has a more complex physical and chemical constitution. A well prepared espresso has a reddish-brown foam called crema that floats on the surface. The drink “Americano” is popularly thought to have been named after American soldiers in WW II who found the European way of drinking espresso too strong. Baristas would cut the espresso with hot water for them.

Once brewed, coffee may be presented in a variety of ways. Drip brewed, percolated, or French-pressed coffee may be served with no additives (colloquially known as black) or with either sugar, or milk/cream, or both. When served cold, it is called iced coffee.

Espresso-based coffee has a wide variety of possible presentations. In its most basic form, it is served alone as a “shot” or in the more watered down style café américano—a shot or two of espresso with hot water. The Americano should be served with the espresso shots on top of the hot water to preserve the crema. Milk can be added in various forms to espresso: steamed milk makes a caffè latte, equal parts espresso and milk froth make a cappuccino, and a dollop of hot, foamed milk on top creates a caffè macchiato.

A number of products are sold for the convenience of consumers who do not want to prepare their own coffee. Instant coffee is dried into soluble powder or freeze dried into granules that can be quickly dissolved in hot water. Canned coffee has been popular in Asian countries for many years, particularly in Japan and South Korea. Vending machines typically sell varieties of flavored canned coffee, much like brewed or percolated coffee, available both hot and cold. Japanese convenience stores and groceries also have a wide availability of bottled coffee drinks, which are typically lightly sweetened and pre-blended with milk. Bottled coffee drinks are also consumed in the United States. Liquid coffee concentrates are sometimes used in large institutional situations where coffee needs to be produced for thousands of people at the same time. It is described as having a flavor about as good as low-grade robusta coffee and costs about 10 cents a cup to produce. The machines used can process up to 500 cups an hour, or 1,000 if the water is preheated.

There is no denying of the increasing popularity of coffee drinks around the world; Starbucks, alone, has a market capitalization of over $14 billion. But picky coffee drinkers have four common complaints about the status quo, and it is keeping a lot of them away from coffee shops today: (1) “the coffee shop can't make my coffee consistently. Sometimes it's good, sometimes it's bad;” (2) “the lines, especially during the morning rush, are too long. I have waited over a 20 minutes to get my coffee in the morning;” (3) 1 always have to spend some time getting it to the way I like (e.g. adding sweetener or cream);” and (4) “I like a drink that is not exactly on the menu and the shop has trouble getting it right when I make my special request.”

Despite the mystique of the Italian word “Barista”, one need only observe one for a few minutes to realize that they are doing a few repeated tasks in different orders and amounts. The fundamental tasks involved are: (1) making espresso; (2) making drip coffee; (3) filling a cup with drip coffee; (4) steaming milk; (5) adding “additives” (e.g. mocha powders, flavored syrups, etc); and (6) pouring hot water for tea.

These are all tasks that can be done faster, cheaper and with more precision by a machine than by people. In fact, almost of these tasks are already being done by a machine, with a human doing the final “assembly”. Let's examine the complaints one-by-one.

### 1. Inconsistency

Especially for the espresso-drink consumer, getting a coffee drink is a crap-shoot. With three or more ingredients involved, there is tremendous room for variation: the espresso shots vary in volume and intensity, the milk is steamed to a different temperature, and the other additives (chocolate, for example) are usually added in “spoonfuls” or “pumps”, which can be big or small, depending on who is doing it. The employees of the coffee shop, being only human, are physically incapable of making precisely the same cup every time. The only thing you can count on is that it will never taste the same twice.

### 2. The Wait

Since making coffee involves a few limited tasks (not to mention ringing up the register) a store's throughput is limited by the skills of its employees, the quantity of its employees and the equipment available. Since such a large percentage of the business occurs early in the morning, the bleary-eyed staff quickly falls behind demand. This can also make staffing a bit difficult, as so much business is conducted in a few short hours (with much of the day's coffee being sold between 7 AM and 9 AM).

### 3. Customization

Most people devote some period of time to personalize their coffee (and with Time magazine naming “You” Person of the Year in 2006, your personal desires matter as much as ever). If the ingredients they require are behind the counter, they must communicate their request in an imprecise way that won't frustrate or embarrass themselves. Normally, this occurs by saying something like “Could you add a half a spoonful of cinnamon?” Requiring precision, for example, “Could you add 16 grams of cinnamon?” would likely elicit laughter.

When the ingredients required are available to the customer, they usually need to go to an island station where milk, cream, sweeteners, etc. are located. There, they must compete for space with anyone else doctoring their coffee. During peak hours, this can be quite frustrating, especially if you are late for work and holding a hot cup of coffee that is burning your hand.

4. The Cost “The 5-dollar coffee” has become a pop-culture saying. Of course, it is not the ingredients that make it $5, but the staff (with their overtime and health care plan) and the overhead of the luxurious store. But most customers take their coffee to-go, so most of the space of the store goes to support a minority of the customers. The customer who grabs a cup of coffee and leaves is far more profitable for the business owner than one who takes the same drink and occupies a table, consumes heating/air-conditioning and electricity for light and their computer for a few hours and then requires the staff to clean up after them. This need for space requires the shop to have extra (and sometimes very expensive) square footage, but these customers rarely make additional purchases after the initial purchase is made.

In the past hundred years, from private kitchens to offices, from restaurants to coffee shops, the manner for serving coffee has not substantially changed. To make a cup of coffee, certain human actions of physically touching the ingredients, such as milk, sugar, and the like, by either a server or by the person himself are required. What is desired is a system in which the customers can make their coffee recipes virtually on their computers, place their orders online, and go to the designated places to pick up their coffees which are prepared by the computerized machines.

### SUMMARY OF THE INVENTION

The present invention teaches a method, system and apparatus for the automated ordering and dispensing of beverages of consistent quality.

The system for automated coffee service comprises: (1) a central server computer communicatively coupled to the Internet; (2) a central database associated with the central server; (3) one or more local server computers communicatively coupled to the central server computer through the Internet, each of which is associated with a machine for making a food product according to commands from the local server computer; (4) at least one client computer communicatively coupled to the central server computer through the Internet; (5) a first software application running in the at least one client computer which enables a user to communicate with the central server computer through the Internet; (6) a second software application running in the central server computer which enables the central server computer to communicate with the client computer and with the local server computers through the Internet; (7) a third software application running in the local server computers which enables the local server computers to communicate with the central server computer through the Internet. The first software application provides a user interface through which the user makes a customized order by dragging various icons representing various ingredients to an icon representing a cup, or other type of container, using a mouse coupled to the client computer and submits the customized order to the central server via the Internet. The second software application processes the data received from the user and sends a specification message for the order to a local server computer designated by the user, the specification message comprising a reference number associated with the user's customized order, recipe data and timing data. The third software application transforms the specification message received from the central server computer into commands for the machine to make a food product according to the recipe data and the timing data for pick-up. The machine has at least two dispensers so that various orders can be delivered concurrently. The food product can be any beverage or food which can be prepared by machines, such as mixed alcoholic drinks, coffee, tea, salads, burritos, etc.

In one aspect, the invention encompasses a way to deliver a consistent quality of a beverage, independent of dispensing location and the workload and expertise of sales staff. In another aspect, the invention encompasses a way to have the beverage dispensing facility prepare beverage to specification, containing all desired “add-ins” without requiring the consumer to physically add additional ingredients. In another aspect, the present invention encompasses a way for the consumer to select or optimize (tweak) the taste of a dispensed by being able to vary the beverage individual ingredients in a controlled fashion via a user interface, until the optimum mixture is obtained, and saving that ingredient setting for placing future orders. In the alternative, the consumer may allow the beverage machine to present a series of “tweaks” to the consumer, and from the responses, identify over time the optimum formula for the beverage tasting best to the consumer. In another aspect, the invention encompasses a way for a consumer to select a desired beverage formula from a remote location, and transmit the order to a beverage dispensing facility for fulfillment and pickup, as well as a way for a beverage dispensing facility to receive orders either remotely (usually electronically via phone or internet), or on site and prepare the beverage for pick-up by the customer within a predetermined time interval. In another aspect, the invention encompasses a way for the consumer to determine the approximate travel time between the consumer's ordering location and the dispensing location in order to estimate pick-up time.

In another aspect, the invention encompasses a way to maintain quality control of a beverage dispensing station by setting a limit on the time after preparation that a perishable prepared beverage can be stored before being delivered to the consumer. In another aspect, the invention encompasses a way that a consumer can order a prepared beverage, and when the beverage is ready, pick up and pay for the order in a secure fashion. In another aspect, the invention encompasses a way that a beverage dispensing facility can electronically notify a consumer that a previously ordered beverage is ready for pick-up. In yet another aspect, the invention encompasses a standardized way to prepare dispensed beverages of consistent quality, in both high volume and low volume settings, depending on the number of customers requiring service at once. In another aspect, the invention encompasses a way of gathering data about customers who electronically order beverages from a dispensing facility, and using that data to facilitate future orders for that customer. In another aspect, the invention encompasses a way for one consumer to allow a third party to order another consumer's exact beverage formula. In another aspect of the invention, the customer is presented with a dynamic listing of the nutrition information as the customer is selecting the ingredients for to make a particular beverage. In another aspect, the invention encompasses automated beverage dispensing units which can receive orders, prepare the beverage, dispense and receive payment for the same without need of a human worker to perform the duties. In yet another aspect, the invention encompasses a way of obtaining consumer pre-authorization for price increases on automated billing on beverage purchases, as well as mining data from the customers' ordering habits for further marketing purposes. Further aspects and details of the invention can be easily ascertained by a person of ordinary skill in the art from a perusal of the detailed description of the invention.

### BRIEF DESCRIPTION THE DRAWINGS

FIG. 1 is a schematic diagram illustrating a system for automated coffee service according to the present invention;

FIG. 2 is a schematic block diagram further illustrating the system of FIG. 1;

FIG. 3 is a block flow diagram illustrating the general dataflow process of the system in FIG. 2;

FIG. 4 is a schematic diagram illustrating a login screen of the user interface supported by the system of FIG. 2;

FIGS. 5-7 are schematic diagram illustrating a screen for the user to create a profile for a personalized coffee recipe;

FIG. 8 is a schematic diagram illustrating a variant of the screen in FIG. 5 with a different “look and feel”;

FIG. 9 is a schematic diagram illustrating a screen for pickup location which is called “My Locations”;

FIG. 10 is a schematic diagram illustrating a screen for pickup timing which is called “My Timetables”;

FIG. 11 is a schematic diagram illustrating a screen for making a user's account which is called “My Account”;

FIG. 12 is a schematic diagram illustrating a screen for an order which is called “My Orders”;

FIG. 13 is a schematic diagram illustrating a screen for the user's recipe sharing which is called “My Friends”;

FIG. 14 is a schematic diagram illustrating a screen for adjusting standard recipe which is called “Tweaker”;

FIG. 15 is a schematic diagram illustrating a screen for a variation of the Tweaker concept which is called “Optometrist”;

FIG. 16 is a block flow diagram illustrating a process for a user to place an order online;

FIG. 17 is a schematic diagram illustrating an exemplary setup of the service station according to the invention;

FIG. 18 is a block flow diagram illustrating a process for a service station to fulfill and deliver an order;

FIG. 19 is a block flow diagram illustrating a low-volume sub-process of the process in FIG. 18;

FIG. 20 is a block flow diagram illustrating a high-volume sub-process of the process in FIG. 18; and

FIG. 21 is a block flow diagram illustrating a process for pick-up after the ordered drink is ready.

### DESCRIPTION OF THE INVENTION

While the present invention may be embodied in many different forms, designs or configurations, for the purpose of promoting an understanding of the principles of the invention, reference will be made to the embodiments illustrated in the drawings and specific language will be used to describe the same. It will nevertheless be understood that no limitation of the scope of the invention is thereby intended. Any alterations and further implementations of the principles of the invention as described herein are contemplated as would normally occur to one skilled in the art to which the invention relates.

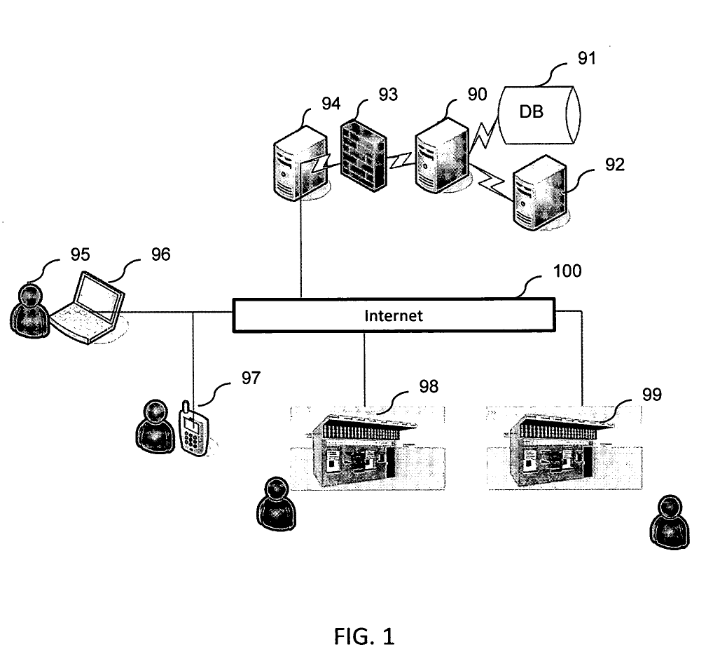

The present invention, as illustrated in FIG. 1, is a combination of a web-based software platform that collects and creates highly-customized coffee orders and machines that fulfill those orders. The web-based software platform runs across the application server 90, the web server 94, the Internet 100, the user's browser 96, and the service stations 98-99. The customers information is stored in the database 91 associated with the application server 90. For security purpose, a firewall 93 is incorporated between the web server 94 and the application server 90. The customers designs their drink and gets them made exactly to their specifications in one of many convenient locations—transforming the customer into an artist with a virtually limitless palette, if he should choose to take full advantage. In operation, one could place an order a little in advance, rendezvousing with the drink when it is ready, or retrieving it from warm storage shortly after it is ready, virtually eliminating the wait and the crowds. As an example, the user 95 creates and tweaks his drink through the browser 96 and places his order online. His order is sent to the application server 90 via the Internet 100. The application server 90 stores the data in the database 91, and identifies which location the user wants to pick up his drink. Then, the application server 90 sends the user's recipe, his timetable and pick-up number to a service station 98 which is designated by the user in his order. The service station 98 prepares the drink according to the user's recipe and timetable. When the drink is ready, the service station 98 sends to the application server 90 a status report. The application server 90 then sends to the user 95 a message through the e-mail server 92 if requested. The message can be an automatic phone message sent to regular telephone or cell-phone, a textual message to the user's mobile phone, or an e-mail sent to the user's computer or/and e-mail-enabled mobile phone. The user 95 then comes to the service station 98 and enters his pick-up number (e.g. a combination of phone number and PIN). After the pick-up number is confirmed, the drink is delivered to the user. If a user has an account and has already saved his favorite drink in the system, he may place his order using cell-phone 97 or place his order in person at any service station.

### I. The System Architecture

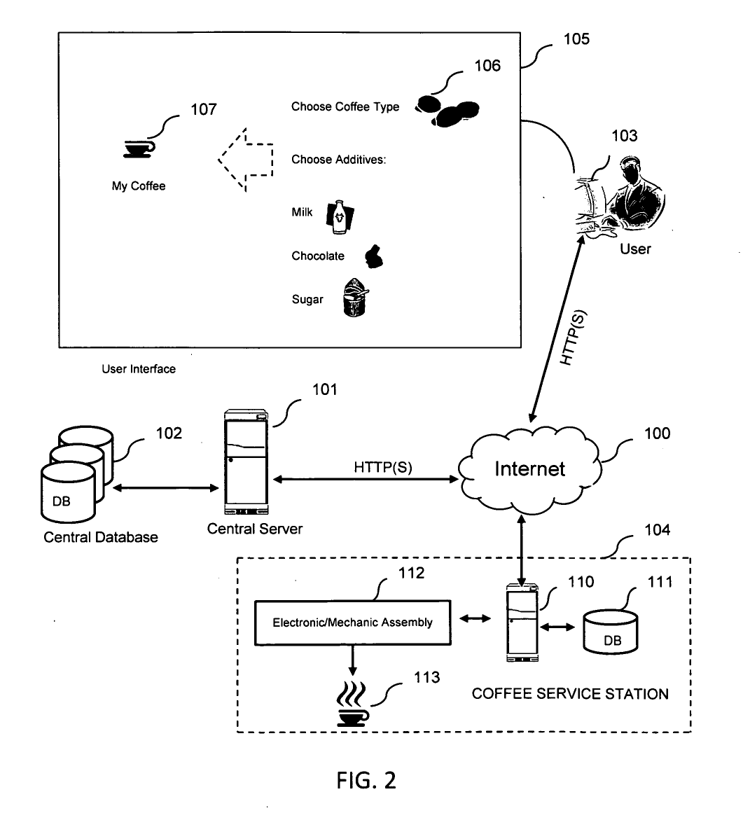

FIG. 2 is a schematic block diagram illustrating a system for automated coffee service according to the present invention. The system includes a central server computer 101 communicatively coupled to the Internet 100, a central database 102 associated with the central server 101, at least one service station 104, and at least one client computer 103 communicatively coupled to the Internet 100.

The client computer 103 can be a desktop, a laptop, a PDA, or a mobile phone with Internet browsing functions. The user can communicate with the central server computer 101 and make an offsite order from the computer 103 through a user interface 105 supported by a client application running across the client computer 103, the Internet 100, and the central server computer 101.

The central server computer 101 is communicatively connected to the local server computer 110 in each service station 104. The local server computer 110 is also coupled to an electronic and mechanical assembly 112 which executes the commands from the local server computer 110. The local server computer 110 supports a software application which enables the electronic and mechanical assembly 112 to make and deliver a drink 113 pursuant to a customized order placed by the user through the Internet 100.

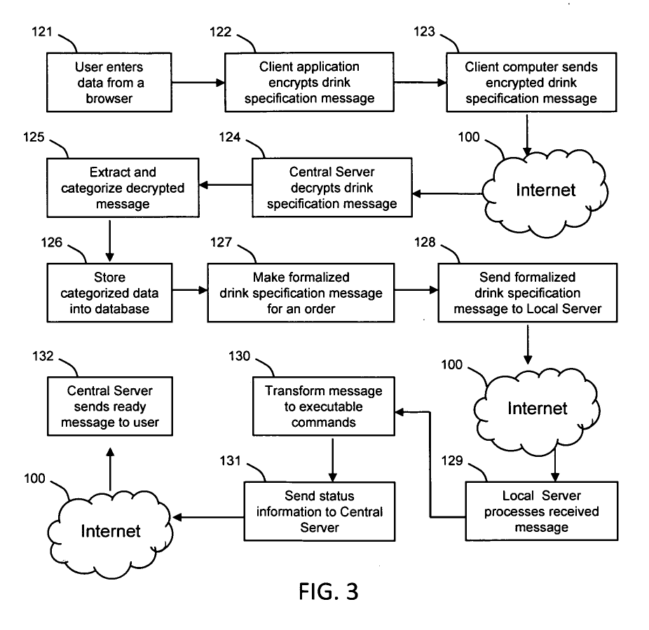

FIG. 3 is a block flow diagram illustrating the data flow in a service operation according to the invention. With reference both to FIG. 2 and FIG. 3, the data flow includes the following steps:

Step 121: Upon login with the web-based client application supported by the central server 101, the user enters his order through a user interface 105.

Step 122: The client application encrypts the drink specification messages representing the user's personalized order, pick up schedule and other information required for the fulfillment of the order.

Step 123: The client computer 103 sends the encrypted drink specification messages to the central server 101 via the Internet 100.

Step 124: The central server 101 decrypts the drink specification messages received from the client computer 103.

Step 125: The server application that runs in the central server 101 extracts and categorizes the decrypted message.

Step 126: The server application stores the categorized data into the database 102 associated with the central server 101.

Step 127: The server application creates a formalized drink specification message for the user's order. The formalized drink specification message includes, but not limited to, the user's designated location of service station, his timetable, and his recipe.

Step 128: The server application sends the formalized drink specification message to the designated local server 110 via the Internet 100.

Step 129: The local server 110 processes the received drink specification message.

Step 130: The local server 110 transforms the received data into a set of commands which are executable by the electronic and mechanical assembly 112.

Step 131: The local server 110 sends status information back to the central server 101 via the Internet 100.

Step 132: The central server 101 sends a message, such as a “your coffee is ready” message to the user via the Internet 100.

### II. The User Interface

Referring back to FIG. 2, the user interface 105 supported by the client application running across the client computer 103, the Internet 100, and the central server computer 101 enables the user to communicate with the central server computer 101. It provides a number of virtual means for the user to create a formula for making a cup of coffee according to his personal preference by dragging a various visual cues representing different ingredients, such as the icon for coffee 106, into a visual cue representing a cup 107 using a mouse coupled to the computer 103.

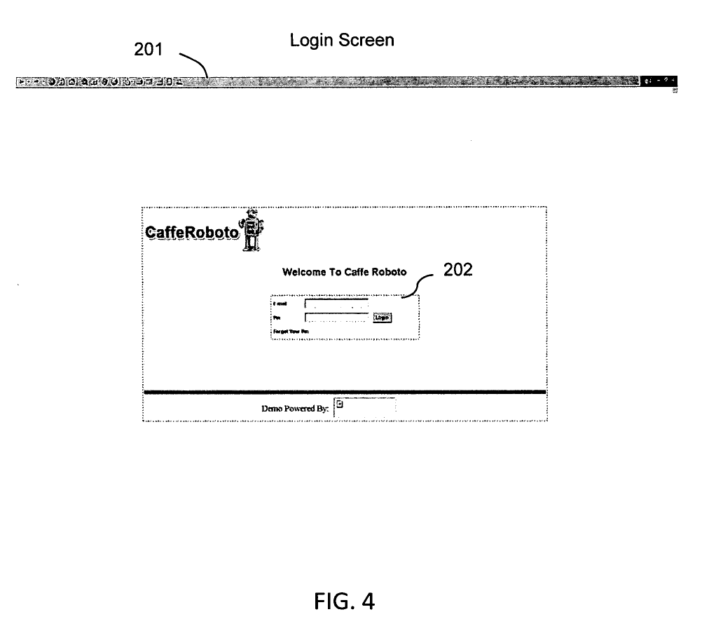

The user interface 105 can be implemented into different formats with different “look and feel”. As an example, introduced here below with reference to FIG. 4 through FIG. 15 is a typical implementation of the user interface according to the spirit of this invention.

FIG. 4 is a schematic diagram illustrating a login screen 201 of the user interface, which is used to identify the user and allows for access to the user's drink and account history, while enabling the establishment of new drinks. The login screen has two boxes 202 for a user to enter user name and password. In a typical implementation, the user's e-mail address can be used as “user name”. When a user opens an account, he may set his unique password or PIN. By entering the correct user name and password, he is directed to the other screens of the user interface.

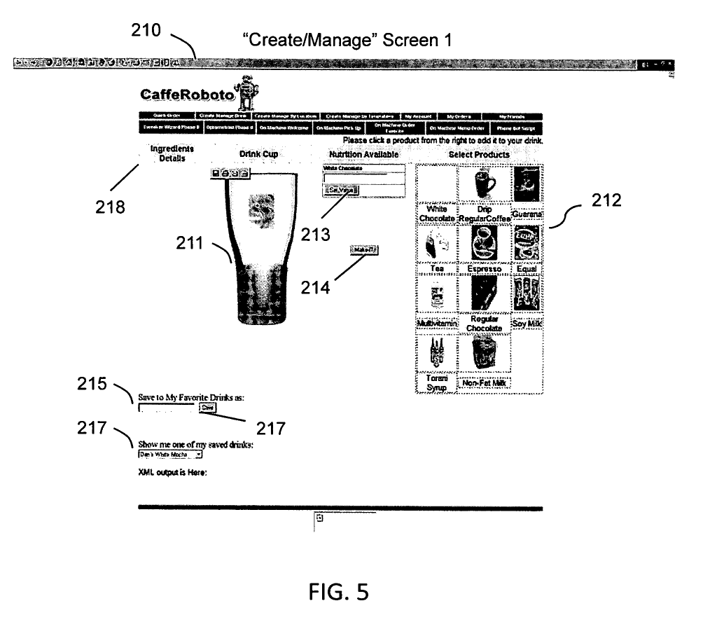

FIGS. 5-7 illustrate a number of means in the user interface for making a personalized recipe in the “Create/Manage”. In FIG. 5, the screen 210 shows how a user would drag and drop drink ingredients into a virtual cup 211, noting the precise quantity of each ingredient. The user may select type and size of the cup for his drink by clicking the virtual cup 221. The screen provides an array of icons of ingredients 212, each of which represents an ingredient available to be added in to the cup 221. The user may choose an ingredient from the array 212 by clicking the icon, and set the amount of the ingredient by clicking a virtual button 213. Then, the user adds the selected ingredient to the cup 211 by clicking a virtual button 214. When the user drags an ingredient, such as white chocolate, into the cup 221, the icon of the ingredient appears in the virtual cup 221, indicating that the ingredient has been added to the cup 221 already. The screen also provides a means for the user to save the newly created recipe. As an example, the means includes a box 215 for entering textual information and a virtual button of “Save” 216. The green also includes a means for the user to modify an existing off-the-shelf recipe from a list of preset recipes, adding or deleting ingredients or modifying the ingredient quantities. As an example, the means can be implemented as a pulling-down list 217. The user may delete one or more already added ingredients from the virtual cup. For another example, to remove an added ingredient from the virtual cup, the user may drag the ingredient icon and drop it into the array of ingredient icons or somewhere else. The screen also includes a means 218, which can be implemented as a dynamic table, for indicating the name and amount ingredients added to the virtual cup 211.

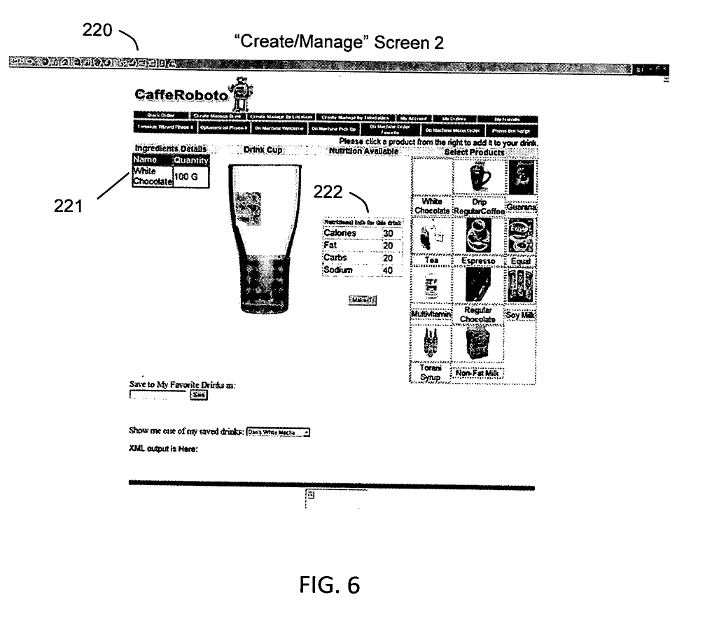

In FIG. 6, the screen 220 shows the creation of the personalized recipe. As the ingredients are added, a tally of the ingredients is kept as the nutritional information is updated. The name and amount of ingredient added to the virtual cup is shown in an ingredient table 221. The screen includes a means, such as a dynamic table 222, for indicating the nutritional information for the ingredients added. At any point during the process of dragging and dropping, the user may save his recipe for placing an order or simply for later reference.

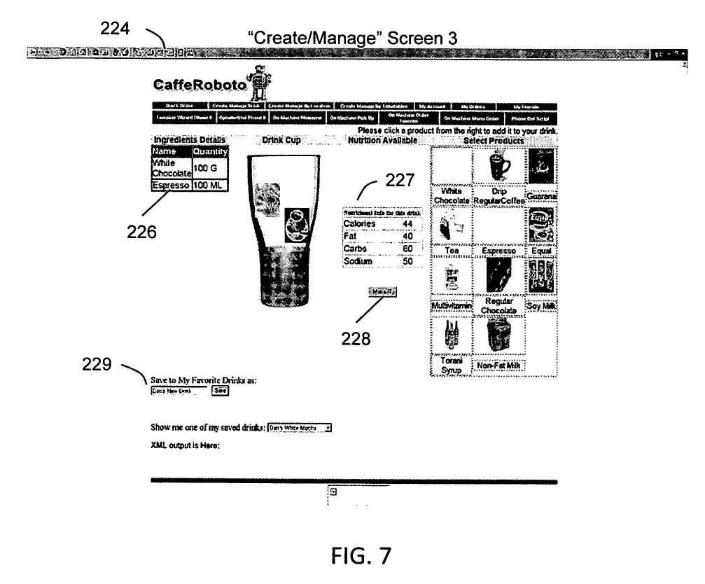

In FIG. 7, the screen 224 shows the ability to call up an existing drink for modification. For example, the user chooses “Dan's White Mocha” from the list of the saved recipe 225. The screen automatically shows the ingredient details 226 and the nutritional information details 227. After the user modifies the recipe by either adding a new ingredient or changing the amount of the existing ingredients, he clicks the button “Make It” 228. He is prompted to name and save the newly created drink from the saving means 229, which includes a box for entering textual information and virtual button.

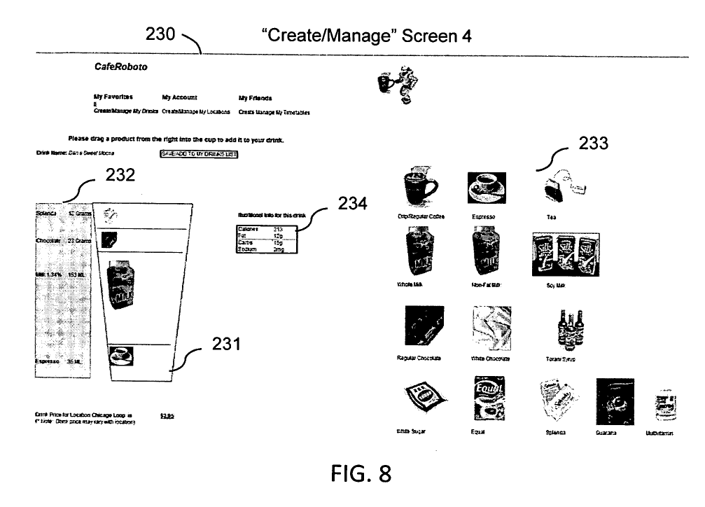

FIG. 8 is a schematic diagram illustrating another manifestation 230 of the “Create/Manage” screen with a more organized drink view of virtual cup 231. The screen provides an array of icons of ingredients 233, each of which represents an ingredient available to be added in to the cup 231. The screen also provides a nutritional information table 234, which includes textual information about the amounts of the standard nutritional factors included in the drink, such as sugar, fat, calories, sodium, etc. The screen also provides an ingredient indication bar 232 which is dynamically updated as the drink's recipe is changed. The ingredient indication bar 232 can be configured into different sections with different colors representing different ingredients. For example, a section of milky white color in the bar represents the ingredient of milk and a section of coffee color represents the ingredient of espresso. From the height of a colored section in the ingredient indication bar 232, the user may estimate the percentage of the ingredient in the cup 231. When the user drags an icon from the array of icons of ingredients 233 into the cup 231, the dragged icon appears in the cup 231, and at the same time, both the nutritional information table 234 and the ingredient indication bar 232 are updated accordingly. There are several ways to modify the amounts of each ingredient in the cup 231. For example, the user may change the type and amount by right-clicking an ingredient icon in the cup 231 or by right-clicking a specific section of the ingredient indication bar 232 and then changing the amount from a pulling down list triggered by the right clicking. In one implementation, when the user drags an icon from the array of icons of ingredients 233, each “dragging” represents a unit of amount of the ingredients. For example, if the user makes five “dragging” of espresso and one “dragging” of milk into the cup 231, his recipe will includes five units of drip coffee and one unit of milk. In another implementation, the user may first set the amount of a selected ingredient by right-clicking the icon, and then drag the icon to the cup 231. After the user drops the icon into the cup 231, the icon disappears from the array of icons 233 but appears in the cup 231.

In the preferred embodiment, the user interface includes a means for warning the user about the nutritional information on the drink according to the recipe created by the user. For example, if the user inputs a ratio of sugar that seems likely to be a mistake into the virtual cup, the screen provides a pop-up message which includes some nutritional comments on the recipe and recommendations for change. The user interface may also include a means for limiting the maximal amount of an ingredient that the user may add to the recipe. For example, if the amount of sugar added to the cup reaches a preset threshold related to the solubility of that quantity of sugar given the amount of liquid, the screen provides a pop-up message telling the user that he cannot add more sugar into the cup. These measures may effectively prevent a user from making drinks that would be lumpy, unable to be sustained in a liquid format and generally avoid defective products.

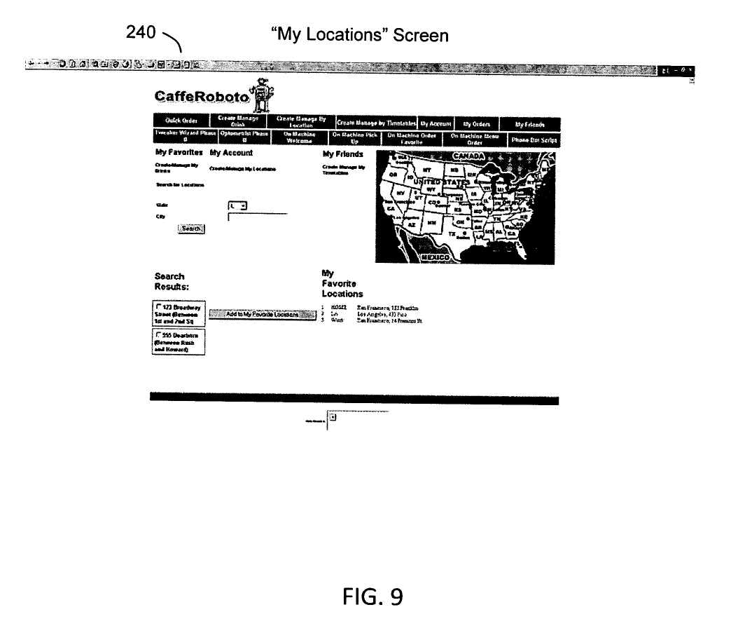

FIG. 9 is a schematic diagram illustrating a screen 240 for pickup location which is called “My Locations”. The principle of the My Locations screen is to identify machine locations that may serve the user. As it is expected that there will be a great number of machines throughout the world (and even within a city), the user identifies a smaller list of machines where his order may be sent for fulfillment and pickup. The screen provides a search means with which the user may find the locations of the service station by entering a zip code or city's name. The screen may also provide a means for saving the user's favorite locations.

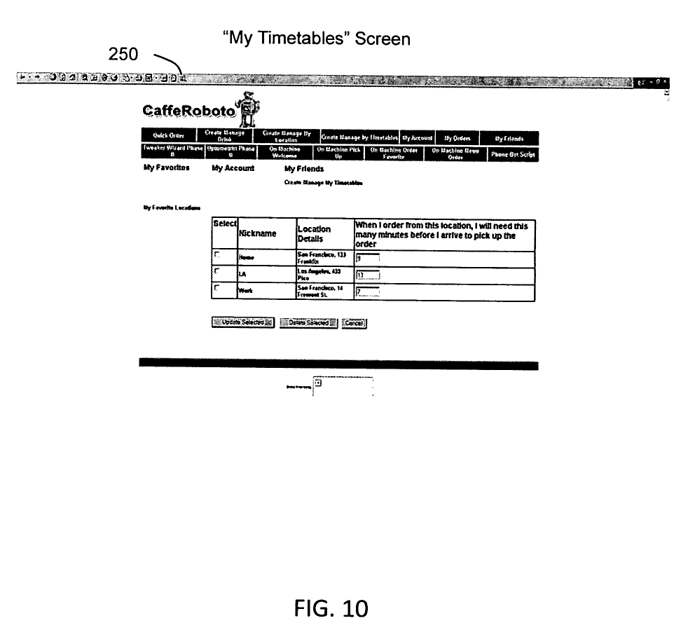

FIG. 10 is a schematic diagram illustrating a screen 250 for pickup timing which is called “My Timetables”. The My Timetables screen matches machine location to likely travel scenarios. For example, if there is a machine close to the user's home and he usually walks to it for 7 minutes, he creates a timetable called “Home” to tell the application that he expects the drink to be ready in 7 minutes at the machine associated with the “Home” timetable. Similarly, if he stops by a different machine on the way to work and it takes 30 minutes to get there, he may create a timetable called “Work” that indicates that the order should be ready at the machine associated with the “Work” timetable in 30 minutes.

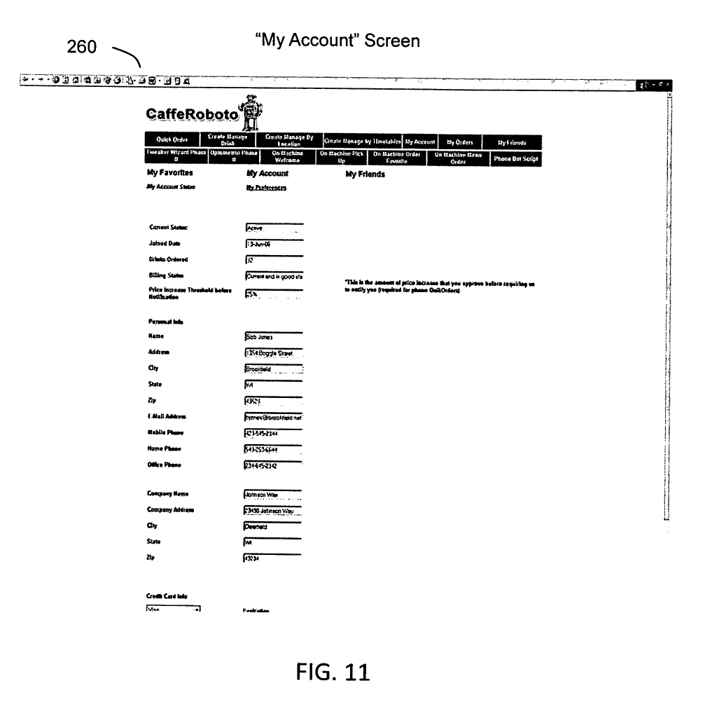

FIG. 11 is a schematic diagram illustrating a screen 260 for making a user's account which is called “My Account”. The main purpose of My Account screen is to house the important contact and preference information of the user, such as Name, Address, E-mail, Credit Card info, etc. Once again, all the information is maintained in the database at the central server. When the user places an order for a pick-up at an indicated service station, the local service computer at the service station only receives the specification about the user's recipe, timetable, and reference number.

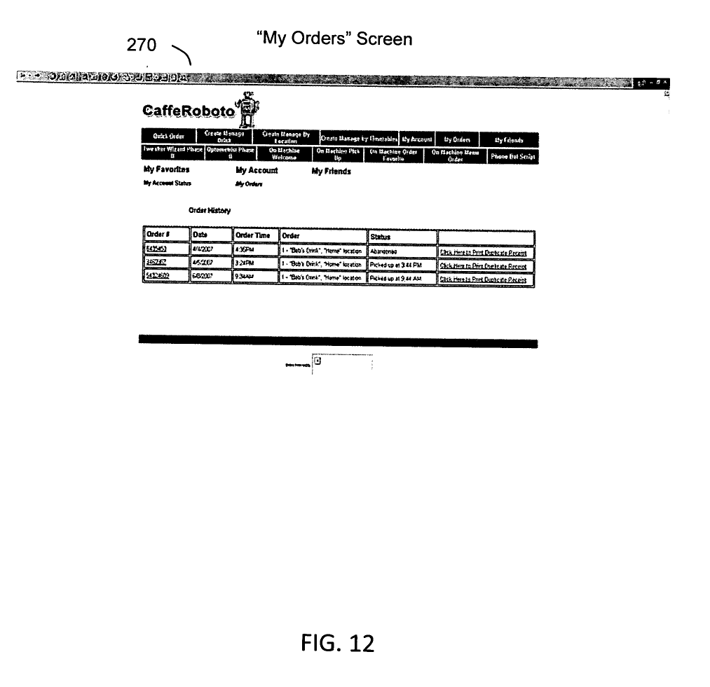

FIG. 12 is a schematic diagram illustrating a screen 270 for an order which is called “My Orders”. The screen shows a history of recent orders. The primary purpose of such a screen is to give the user visibility to the history of recent orders, as well as the status of the current order. Duplicate receipts can be printed on the user's printer and previous orders can be reviewed to see, for example, a recipe used in a previous order.

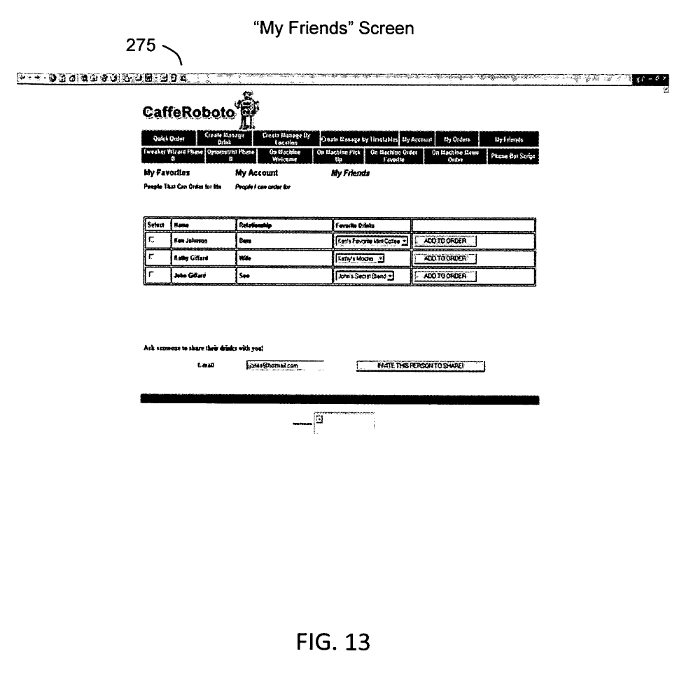

FIG. 13 is a schematic diagram illustrating a screen 275 for the user's recipe sharing which is called “My Friends”. This screen provides a means to allow others to know and order the user's favorite drinks. It is quite common for others, e.g. spouses, friends and assistants, to bring coffee to another individual. This feature allows the user to grant access to his favorite drink recipes to another for easy ordering and takes away the guesswork often associated with getting food and drink for another. For example, by clicking a virtual button “Share with Friends”, the user is prompted to enter the recipient's e-mail addresses. An automatic e-mail message will be sent to the entered e-mail addresses. The “friend” may place an order of the user's recipe through the server's main web site, by calling a phone number following a set of instructions, or by placing an order in person at the service station by entering a piece of information such as an ID number or reference number associated with the saved recipe. Additionally, the “friend” will be able to access the favorite drinks of all those who have designated that person as a “friend”, and will see those drinks on the web site and will be able to add those shared drinks to his order.

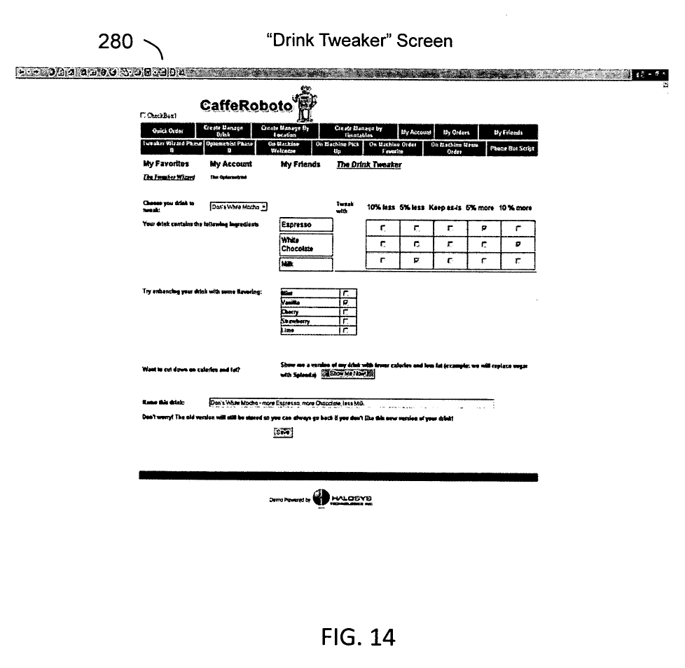

FIG. 14 is a schematic diagram illustrating a screen 280 for adjusting standard recipe which is called “Tweaker”. The concept of the Tweaker goes to the very heart of the value proposition of this invention. Consumers, given a virtually infinite variety of choices, will need some assistance honing in on their perfect drink. Very few people will be able to know that their ideal drink is “234 grams of 1.3% milkfat milk, 94 grams of white chocolate powder, 70 ml of espresso”, etc. Instead, consumers know a general recipe that they like (e.g. a Non-Fat Mocha) and will be able to work from there, modifying it. To help them identify how they might like to modify this “off-the-shelf” recipe, the Tweaker shows the user the original recipe's ingredients, then offers some possible increase and decrease scenarios for each ingredient. In the example above, the user wants to try 5% more espresso and 10% more White Chocolate than the original recipe. These “Tweaks” ultimately form a new drink which is then named with a unique name per the user. After trying it, the user may wish to try tweaking the new drink, or may wish to go back to the previous drink and try the tweaking process over.

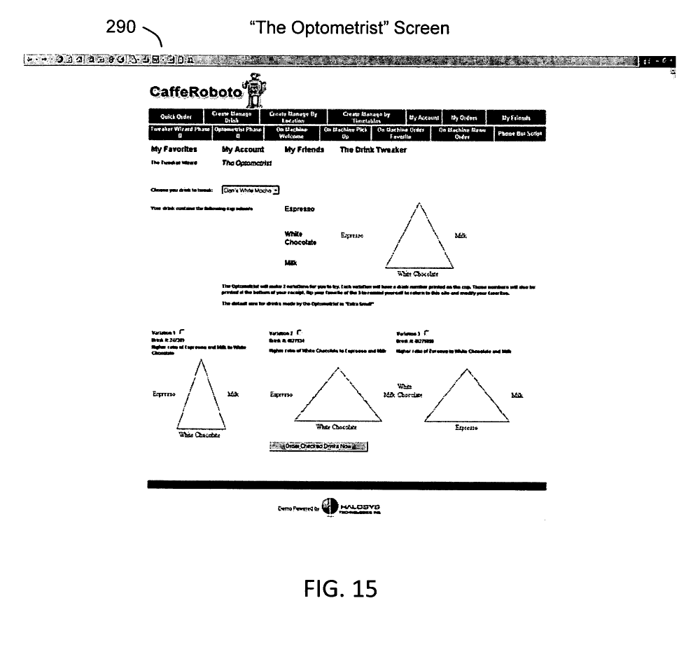

FIG. 15 is a schematic diagram illustrating a screen 290 for a variation of the Tweaker concept which is called “Optometrist”. The Optometrist attempts to use the approach of optometrists to hone in on a user's ideal drink. For those not familiar, an optometrist, in order to find a patient's best prescription, will choose a starting point and iteratively ask the patient to evaluate a prescription, changing a little at a time, as “better, or worse”. Over the course of a few iterations, the optometrist eventually reaches a conclusion about the best prescription by listening to the patient's assessment of “better or worse” for different samples. While tastes do not necessarily have as clearly defined “prescription” as a glasses prescription, the principle can still apply. Using this logic, the system according to this invention takes a recipe that the user likes, and offers slight variants for assessment. If the existing favorite drink is “beaten” by a new drink, it becomes the new favorite against which to evaluate new variations. The screen in FIG. 15 shows how slight variations are concocted, simple by adding or subtracting some amount (e.g. 5%) of one of the ingredients to see if the user enjoys the drink more or less with that change being made. Done iteratively, the user will likely come to a recipe over time that will not be beaten by variations, at which point the user's “ideal” drink has been identified and can be served up regularly for the user.

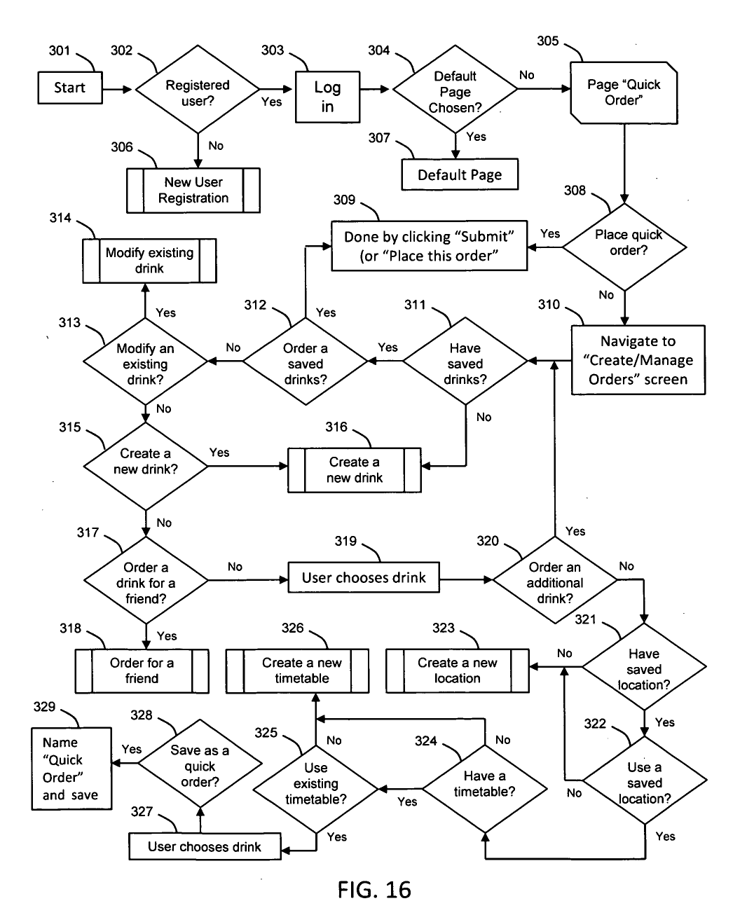

FIG. 16 is a schematic block flow diagram illustrating the general process for the user to place an order using the user interface. The process includes the following steps:

Step 301: The user visits the webpage for placing an order. The webpage is provided by the user interface application supported by the central server 101 in FIG. 2.

Step 302: The user is prompted for registration status. If he is not a registered user, he is directed to the new user registration page 306. If he is a registered user, he is requested to login 303.

Step 303: The user enters his user name and password.

Step 304: The user is prompted for default page selection. If he chooses a default page, he is directed to the default page 307. If he does not choose a default page, he is directed to the “Quick Order” page 305.

Step 308: The user is prompted for quick order. If he chooses a quick order, his order is done 309. If he does not want a quick order, he is directed to the “Create/Manage Orders” page.

Step 311: The user is asked if he has a saved drink. If no, he is directed to the pages to create a new drink 316.

Step 312: If yes in Step 311, he is asked if he wants to order a saved drink. If yes, he places an order of a selected saved drink that he created earlier. His order is done 309.

Step 313: If no in Step 312, the user is asked if he wants to modify an existing drink. If yes, he is directed to the pages to modify an existing drink 314.

Step 315: If no in Step 313, he is asked if he wants to create a new drink. If yes, he is directed to the pages to create a new drink 316.

Step 317: If no in 315, the user is asked if he wants to order a drink for a friend. If yes, he is directed to the pages to place an order for a friend.

Step 319: If no in Step 317, the user is directed to the pages to choose a drink.

Step 320: The user is asked if he wants to order an additional drink. If yes, he is directed to Step 311.

Step 321: If no in Step 320, the user is asked if he has a saved location. If no, the user is directed to the pages to create a new location 323.

Step 322: If yes in Step 321, the user is asked if he wants to use the saved location. If no, he is directed to the pages to create a new location 323.

Step 324: If yes in Step 322, the user is asked if he has an existing timetable created earlier. If no, he is directed to the pages for creating a new timetable 326.

Step 325: If yes in Step 324, the user is asked if he wants to use an existing timetable. If no, he is directed to the pages for creating a new timetable 326.

Step 327: If yes in Step 325, the user is prompted to choose a drink.

Step 328: After a dink is created, the user is asked if he wants to save it as a quick order for future retrieval. If no, his order is done by clicking a button named “submit” or “Place this order” 309.

Step 329: If yes in Step 328, the user is prompted to name the drink and save it as one of his drinks in his list of “Quick Order” 305.

### III. The Central Server Computer

Referring back to FIG. 2, the central server computer 101 is the brain of the overall system. There is a software application running in the central server computer 101 which enables the data transportation between the central server computer 101 and the client computer 103 and the data transportation between the central server computer 101 and the local server computer 110. In operation, the user is required to log on the system via the user interface 105 and create a profile representing an order by a number of simple dragging and clicking actions using a mouse. By clicking a virtual button for placing an order, the drink specification message for the profile is sent to the central server computer 101 over the Internet 100 and is stored in the central database 102. The central server computer 101 processes the message and dispatches the order to a service station 104 in a location chosen by the user. The local server 110 of the service station 104 receives the order, processes it, and transforms it into a set of commands for the electronic and mechanical assembly 112. The assembly 112 then executes the commands and delivers the drink 113 in compliance with the order.

In another preferred embodiment of this invention, the user interface and the related software applications can also support an online forum, such as a discussion page or blog, from which the users can discuss the automated coffee system, best practices, recommendations, drinks, experiences, new ideas, problem solving, etc.

### IV. The Service Stations

Referring back to FIG. 2, each service station is an automated coffee server without human servers involved in the service operation. After the user makes an order online, he is given a reference number. Then, the user comes to the service station and enters a key (information that uniquely identifies him), such as the combination of his phone number and a PIN number. The service station attempts to match the user's key to the reference number associated with the order received from the central server 101 in FIG. 2. If the matching is successful, the service station delivers a drink which is made according to the recipe specified by the order. The service station does not recognize the person who enters the key. It does only recognize the key. If the key is not correct, the service station would inform the customer that the key is erroneous and ask him to re-enter it. Each service station is managed by a local server computer 110 which is associated with an assembly of electronic and mechanical equipments 112. There is a software application running in the local server computer 110 which enables the local server computer 110 to communicate with the central server computer 101 via the Internet. The end user's computer 103 does not communicate with the local server computer 110. The database 111 associated with the local computer server 110 does not store any personal data of the user. In operation, for a user's order, the local computer server 110 receives a drink specification message from the central server computer 101 and extracts the data of the recipe, the data of timing requirements and a reference number associated with the user's order, and then stores the extracted data in the database 111. The software application in the local server computer 110 transforms the extracted data into electronic commands. The electronic and mechanic assembly 112 executes the commands. The execution process includes making a drink pursuant to the recipe in a timely manner, and delivering the drink 113 to the customer who enters the ID information which matches the reference number. The coffee service station 104 does not know the customer's personal information.

In the preferred embodiment, the assembly 112 has at least two machine banks for high-volume and redundancy. Each machine bank is controlled by the local server computer 110. When the local server computer 110 receives an order from the central server computer 101, it commands the first available machine bank to make the drink in compliance with the user's order. Upgrades to the local server computer 110 can be made by the repair/refill team via a USB port, which is a common port on PCs for attaching devices and additional memory for temporary and permanent use, or a CD ROM drive.

The local server computers, such as the server computer 110 in FIG. 2, are communicatively connected to the central server 101 and the central database 102 which are away from the service stations in different locations. There is a web based software application which runs across the central server 101, the central database 102, and each of the local servers in the service stations over the Internet 100. The software application enables each local server computer to communicate with the central server computer 101. The central database 102 associated with the central server 101 is the repository for all information, such as customer data, recipe data, order history, machine inventory data, and supply chain data. The local database 111 is used only to facilitate orders placed at the local service station, to provide additional data for the local service station and to manage the local order queue until the order is fulfilled.

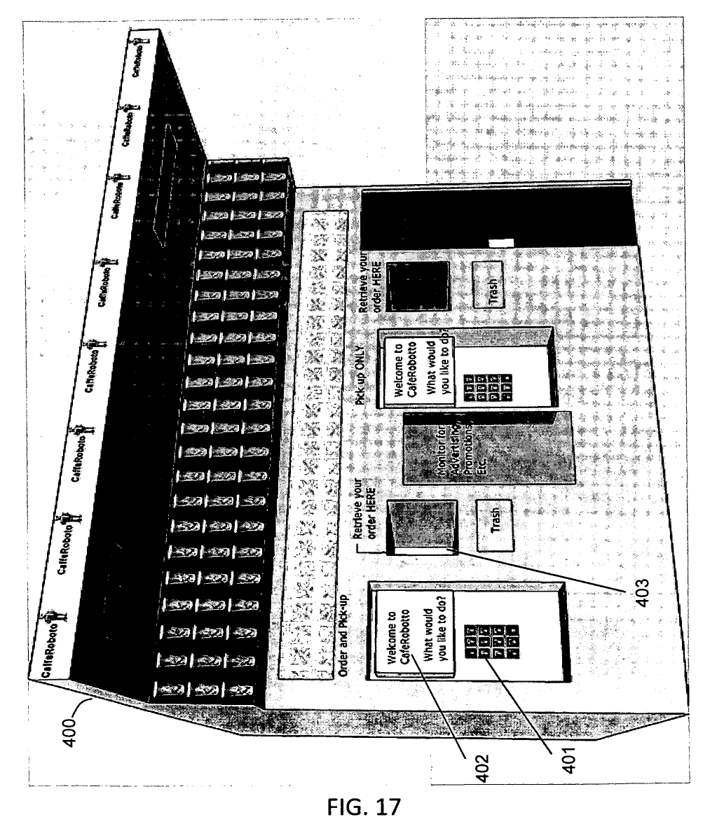

FIG. 17 is a schematic diagram illustrating an exemplary setup 400 of the service station according to the invention. The service station includes a means 401 for identifying a user's order, from which the user enters a digital key such as a number or a combination of a number and letters. When the user enters the digital key, the local server computer in the service station matches the digital key to an order received online and commands the service machine to make and deliver the ordered drink. The service station also includes a means 402 for announcing the status information for an order or other information such as advertising messages. When the drink is ready to pick up, the serving station makes an announcement through the screen 402 and an associated speaker. The service station also includes an automatic window 403 for dispensing the drink to the user. When the drink is ready, the window 403 opens, and the user may pick up his drink from the window. A preset of period of time, such as 60 seconds, after the “your coffee is ready” message is posted, the window is automatically closed. If the user fails to pick up the drink, the drink will be moved to a temporary storage area for up to a preset period of time. To retrieve the drink, the user must enter his reference number again.

In a typical embodiment, at the service station, cash is not acceptable. Customers are encouraged to keep a credit card number with the main server for faster ordering. For “spontaneous” customers, there is a credit card reader slot. No signatures are required, due to the small dollar amounts. Small transaction amounts means that it is cheaper to accept a small amount of fraud than pay large amounts to combat it. It can also be configured to accept payments through Pay-Pal.

### The Machine:

The electronic and mechanical equipments (“the machine”) execute the commands from the local server computer and deliver the ordered product. The machine takes a fresh bottle/cup and moves it from spigot to spigot (or all spigots are centralized so that the cup won't have to move), receiving precisely the exact amount of ingredients required to make the user's customized recipe. The bottle is shaken or the cup is blended and delivered to the customer or stored for later pick-up. The machine's size varies based on how much stock is held, the available real estate, the local environment and how many customers can be handled at once.

### Label Printing:

Quick-drying ink is sprayed on each drink cup/bottle to identify the drink's owner and recipe name. If someone is ordering for a group of people, the drink can read “Tom c/o Jane”. The label acts as sleeve for (i) print drink/user name; (ii) barcode; (iii) drink number; (iv) basic description; (v) order number; and (vi) receipt.

### Machine Architecture:

For each service station, there are a number of redundant “banks” so that half the machine can be down for cleaning, or can suffer a partial shutdown. This also helps during high-volume times. The central server coordinates cleaning based on quiet times (e.g. midnight to 4 AM).

### On-Machine User Interaction:

To the extent possible, the users are encouraged to do as much ordering as possible at their homes via the web-browser. On-machine user interaction is limited to simple orders (for foot traffic customers) and as a way to identify themselves for favorite-drink ordering or drink retrieval. A customer can, for example, type in their phone number and pin number and be guided through a very simple series of questions (e.g. “Would you like your favorite drink, a Medium Mocha, now? Thank you. Your drink will be ready in approximately 1 minute”). Or a customer can order a “standard” drink from a limited menu, and encouraged to tweak the drinker later at his home computer. See below for more on the “Tweaker” concept. The ordering process may include the steps of: (i) touch screen or phone-keypad; (ii) type phone # and pin to get order; (iii) basic ordering possible of standard, menu drinks; (iv) ordering of favorite drinks, customized through web site; and (v) payment possible with credit card slot (no signature).

### Self-Cleaning:

The machine must be largely self-cleaning, but requires regular cleaning to maintain high levels of cleanliness. Restock/Repair crew can do occasional checks to make sure that cleaning is going well. For example, one bank can shut down for several hours during slow times (e.g. Midnight-4:00 AM). Cleaning can utilize boilers for high-temperature water cleaning using the same boilers which make the hot water used for regular orders.

### Inventory:

Inventory levels are dynamically calculated based on drinks served. The information is used to schedule restocking visits. The essential data is calculated on main server based on dispensed quantities of ingredients. It can be verified by weight of ingredients, if scales are integrated.

### Restocking and Maintenance:

As much as possible, restocking receptacles (e.g. milk containers) are designed for easy “plug in, plug out” replacement to minimize restocking time. If standardized gallons of milk are used, the system is built for easy loading of those products since they are likely to be the product the runs out the quickest. For fast restocking, it is easy to “plug in” refills. The restocking data is loaded into system—dates, quantities, location. The system can automatically switch from empty ingredients container to full ones, allowing for larger periods of time between restocking and seamless operations when a container runs out. As an example, the system may try for 2 restockings per week.

### Surveillance Cameras:

Cameras are installed inside and out for security and remote diagnosis of problems. They can be “web cameras” and be used for quality control, e.g. making sure that a drink was produced when the machine THINKS it produced one, and for security, e.g. if a person is illegally using another's account, photos will be taken of the person retrieving the drink. The cameras can also assist with investigations of vandalism.

### Messages to Customers:

Continuous improvement to the system will be heavily influenced by customer feedback. Customers are prompted various messages such as “TIPS: Please visit the feedback section of our website to give us tips on how we can improve!”

### Drink Storage:

When a customer pre-orders a drink, the drink is often ready in advance of the customer's arrival. The machine has the capacity to store a certain quantity of completed drinks. Drinks may be kept warm with warming rods or steam. This also allows the drink to be kept at a customer's desired temperature. There are a limit as to how long the drink can be stored before discarded, e.g. 1 hour. A robotic arm (or similar) will be used to retrieve the stored drink from the storage area and deliver it to the customer.

### Display to Announce Ready Drinks:

The system announces that drinks are ready. One example of announcement format is “First name+last 4 digits of phone”, e.g. Tom XXX-XXX-2443. Another example is “First name plus name of drink,” e.g. Bill—Favorite Latte. The purpose is to create a string of characters that will uniquely identify an order without using an order number or giving away personal data of the user.

### User Security:

Before receiving his order, the customer is required to enter a 4-digit PIN number. This will prevent others from retrieving his drink accidentally or through the intention of theft.

### Choose Temperature of Drink:

The drink comes out at a standardized temperature, but can be warmed by hot steam, hot air or a heating rod to a higher temperature, which is capped to go no higher than a “safe” temperature, to be defined later. Customers have a limited ability to choose the temperature of their drink within safety limits. This is accomplished after the drink is made by inserting a heating rod, such as with steam, into the drink until it reaches the desired temperature. Drinks can be cooled simply be being held in storage without the application of warming technology (e.g. warming rods or steam).

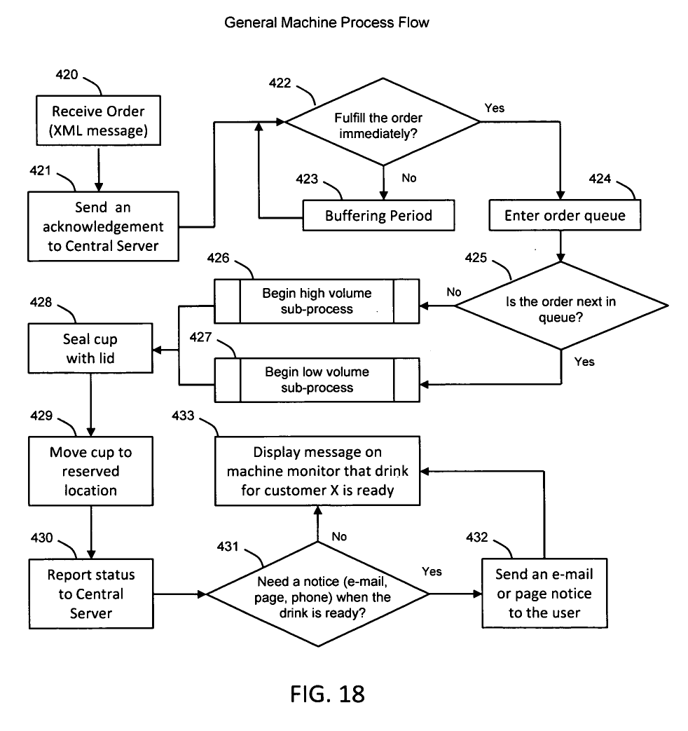

FIG. 18 is a schematic block flow diagram illustrating a process that a service station fulfills an order. The operational software application in the local server computer performs the process, which includes the following steps:

Step 420: The local server computer of the coffee service station receives a drink specification message for an order from the central server computer. The drink specification message includes the data for the user's recipe, the data for timing, the data for the reference number associated with the user's order, and the data for other requirements such as e-mail confirmation. In a typical embodiment, the drink specification message can be implemented as XML format.

Step 421: Upon receipt of the drink specification message, the local server computer sends an acknowledgement back to the central server computer.

Step 422: If the drink specification message includes a timing requirement, the order will be put on hold for a buffering time 423.

Step 424: If the drink specification message does not include a timing requirement or if after the buffering time matures, the local server computer enters the order in the order queue.

Step 425: Check whether the order If the order is next in the queue.

Step 426: If the order is not next in the queue, the operational software application initiates a high volume sub-process.

Step 427: If the order is next in the queue, the operational software application initiates a low volume sub-process.

Step 428: The machine makes the drink according to the user's recipe ad seal the cup with lid.

Step 429: The machine moves the cup to a reserved location for storage until retrieval.

Step 430: Send the status of the order back to the central server computer.

Step 431: Check whether the user needs an automatic notice such as an e-mail or a page message or a phone message when the drink is ready for pickup.

Step 432: If the notice is required, send a message to the user.

Step 433: If no notice is required, or after the notice is sent, display a message on the machine monitor that the drink for customer X (a given name or a reference number) is ready for pick up.

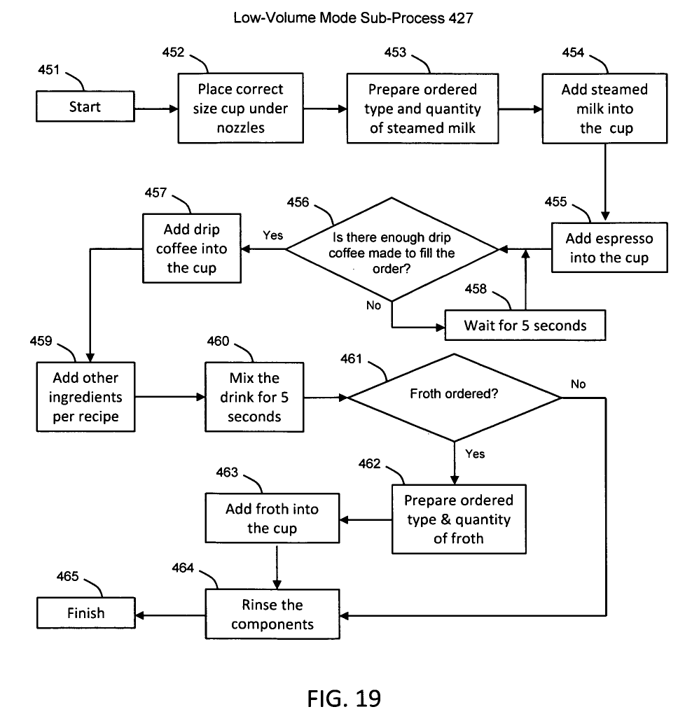

FIG. 19 is a schematic block flow diagram illustrating a low-volume mode process. The process includes the following steps:

Step 451: It is triggered by Step 427 in FIG. 18.

Step 452: The machine places correct size cup under the nozzles associated with various containers of ingredients.

Step 453: Prepare the type and quantity of steamed milk per the user's recipe.

Step 454: Add steamed milk into the cup.

Step 455: Add espresso into the cup.

Step 456: Check if there is enough drip coffee made to fill the order. If no, wait for a preset period of time, such as 5 seconds, so that the sufficient drip coffee is being made 458.

Step 457: When sufficient drip coffee is ready, add drip coffee into the cup.

Step 459: Add other ingredients pursuant to the user's recipe.

Step 460: Mix the drink for a preset period of time, such as 5 seconds.

Step 461: Check whether or not the user's recipe includes froth. If no, goes to Step 464.

Step 462: If the forth is included in the recipe, prepare the ordered type and quantity of froth.

Step 463: Add ordered froth into the cup.

Step 464: Rinse the components.

Step 465: Continued to Step 428 in FIG. 18.

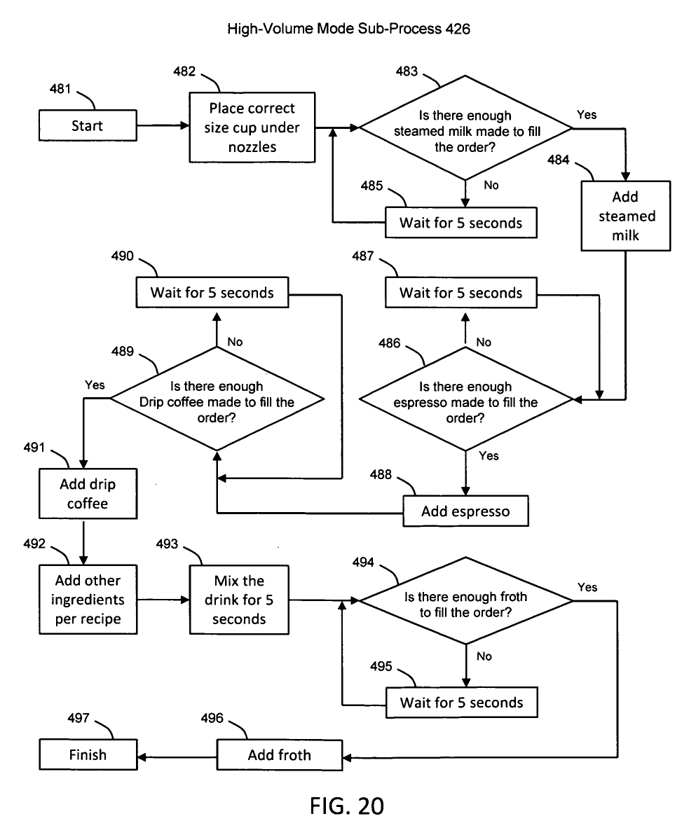

FIG. 20 is a schematic block flow diagram illustrating a high-volume mode process. The process includes the following steps:

Step 481: It is triggered by Step 426 in FIG. 18.

Step 482: The machine places correct size cups under the nozzles associated with various containers of ingredients.

Step 483: Check if there is enough steamed milk made to fill the order. If no, wait for a preset period of time 485, such as 5 seconds, so that the machine prepares enough steamed milk.

Step 484: If yes in Step 483, add steamed milk into the cups.

Step 486: Check if there is enough espresso made to fill the order. If no, wait for a preset period of time 487, such as 5 seconds, so that the machine prepares enough espresso.

Step 488: Add espresso into the cups.

Step 489: Check if there is enough drip coffee made to fill the order. If no, wait for a preset period of time 490, such as 5 seconds, so that the sufficient drip coffee is being made.

Step 491: When sufficient drip coffee is ready, add drip coffee into the cups.

Step 492: Add other ingredients pursuant to the user's recipe.

Step 493: Mix the drink for a preset period of time, such as 5 seconds.

Step 494: Check if there is enough froth to fill the order. If no, wait for a preset period of time 495, such as 5 seconds, so that the machine prepares enough froth.

Step 496: Add the ordered type and quantity of froth into the cups.

Step 497: Continued to Step 428 in FIG. 18.

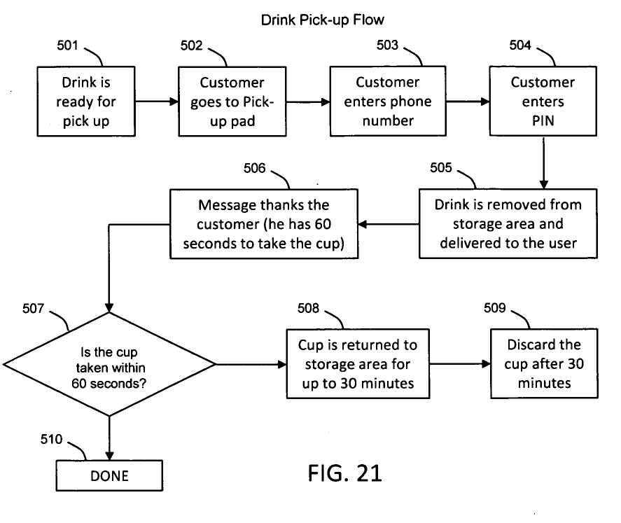

FIG. 21 is a block flow diagram illustrating the process of pick-up after the drink is ready. The process includes the following steps:

Step 501: The machine makes a drink pursuant to the recipe and timetable and the drink is ready for pick-up.

Step 502: The customer who made the order online or using cell phone goes to the service station.

Step 503: The customer enters his reference number for his order such as his phone number.

Step 504: The customer then enters a PIN.

Step 505: After the reference number and PIN are confirmed, the machine moves the drink from the storage area and delivers it to the customer.

Step 506: The machine posts a message at the pick-up area, thanking the customer and warning that he has a certain period of time such as 60 seconds to take the cup.

Step 507: The pick-up is done if the cup is removed within 60 seconds.

Step 508: The cup is returned to storage area for up to 30 minutes if it is not removed within 60 seconds.

Step 509: The machine discards the cup after 30 minutes.

### V. The Ingredients

The ingredients available to make the drinks include the following:

### 1. Milk

Milk is kept in a refrigerated section of the machine. As with all products, the milk can be mixed per the customer's recipe. This allows the customer to have any milk-fat level desired, based on the mixing of non-fat and whole milk to a pre-set precision level (probably 1-2 ml). Milk is steamed before delivery, if required. For busy times, vats of pre-steamed (constantly being steamed) milk can be maintained for faster service. Kinds of milk may include: (i) Nonfat; (ii) Whole; (iii) Soy; (iv) Milks being mixed as needed; and (v) Stored in bags or custom boxes in refrigerator.

### 2. Coffee

A small selection of coffees is kept for the drip coffee. The drip coffee is made in batches, each with a back-up container which can be washed and new coffee can be prepared as the primary batch is consumed. (1) Espresso, which will normally be made per order, except during busy periods where it will be made constantly in larger quantities for faster service; (2) Drip, which has 2-3 varieties, including at least one decaffeinated; (3) Selection of fair-trade coffee as part of the above selection (“fair-trade coffee is a designation that suggests that the coffee growers were fairly compensated for their work); (4) Espresso freshly ground for each cup; and (5) Drip coffee discarded if not dispensed by a certain time (e.g. one hour after brewed).

### 3. Chocolate

Chocolate will be available in liquid or powder form (depending on the configuration of the machine) for hot-chocolates and mocha drinks. Chocolate types may include: (1) standard chocolate; (2) white chocolate; (3) dark chocolate (normally known per the percentage of cocoa, like 75% dark); (4) unsweetened chocolate; (5) sugar-free chocolate; and (5) sugar-free white chocolate.

### 4. Sweeteners

Sweeteners will be available in liquid or powder form for all drinks, measured per the customer's order. Possible sweeteners include (1) sugar, refined and unrefined; (2) NutraSweet; (3) Splenda; and (4) honey.

### 5. Thickeners

Artificial thickeners will be available for customers who want a creamier drink without the calories or fat.

### 6. Foam Maker

For customers who want foam top on their drink, foam can be easily made with steam.

### 7. Whipped Cream Such as Nitrous Oxide Whipped.

8. Other flavorings, such as lemon, cinnamon, etc., in powdered or liquid form.

### 9. Nutritional Supplements

Nutritional supplements are in powdered or liquid form. A selection of nutritional supplements will be available for the drinks. We will work to determine a list of supplements with the least impact on taste but that will meet the needs of the health-conscious consumer. Such supplements may include: (1) Vitamins; (2) Protein; (3) Extra caffeine; (4) Lactaid (for lactose intolerant); (5) Flavor Syrups; 5-15 Flavors, some sugar-free.

### 10. Teas.

A selection of teas will be available. The customer will be able to choose from among the selection and the intensity of the tea. Alternatively, teas may be dispensed into a tea bag and delivered with a cup of hot water.

### 12. Iced Drinks

Iced drinks are made by adding crushed ice to a drink. Shaved ice will be among the ingredients, allowing for “iced” versions of all drinks.

### VI. The Web-Based Software Applications

The principal software application for the system is used to perform various functions, such as profile management, scenario personalization, orders, pricing, promotions, inventory, and product catalog. Given below are a number of examples:

1. Basic drink to start from. The system stores a collection of “standard” recipes to serve as the basis of customized drinks. Customers will typically start with one of these and modify from there.

2. Drag and drop additions. A customer, i.e., the user, drags an icon from the right into the cup, then he is prompted how much to add. He may click on an existing ingredient in the cup to modify the amount.

3. See proportions of ingredients on “virtual cup”. As ingredients are dragged, the user sees the proportions reflected by different colored sections within the cup.

4. Recent drink history for “tweaking” (to be described later). Each customer is able to see the last 10 drinks that he ordered with the exact recipe for “tweaking”.

5. Nutritional information. For each drink, the nutritional information can be calculated and shared with the customer on the web site as the drink is being designed. As ingredients are added and subtracted, the nutritional information updates dynamically. It may be printed on the cup or on the label (which may also serve as a receipt). This includes calories, fat, sodium, etc. The customer is able to see the nutritional information changing as they modify the drink. Similarly, an “allergy-alert” could be created. If the customer states he is allergic to a certain thing, a check could be done to ensure that none of the ingredients has that (only available for the most common allergies such as peanuts, lactose, etc.)

6. Gift certificates. Electronic gift certificates are available to credit accounts.

7. Promotions. Occasional promotions will introduce new ingredients, new locations and new features, as well as any specials.

8. Data mining (for marketing and supply chain). For the management of the company all of the information gathered provides the basis of a database marketing opportunity, as so much will be known about the preferences and habits of the customer. This data can also be used to provide the basis for identifying suggestions to a consumer based on the mathematical regression of data used by demographically similar customers. This is based on research that has shown that people with a common ancestry or background will often share food preferences.

9. Scaling drinks. If, for example, a customer creates a drink for a 12 ounce cup that has more than 12 ounces of products in it, the recipe can be scaled proportionally so that the total equals 12 ounces.

10. “Tell me about my cup”. In a typical configuration, the data includes: When was the coffee picked? Where? Milk date? When was the milk produced? When is it to expire? All this data can be available to the customer and can be assembled into a “story” (e.g. “Your coffee was picked in late March of 2008 in eastern Colombia in the Rodriguez plantation, and blended with milk from Carmel, Calif. . . . ”). As the data about the stocked ingredients reside on the same database, the system can tell the customer details about each ingredient that went into the cup.

11. “The Tweaker”. This interactive “wizard” is used to make the customer's coffee better (asks questions and makes suggestions). The concept of the Tweaker goes to the very heart of the Automated Coffee System value proposition. Consumers, given a virtually infinite variety of choices, will need some assistance honing in on their perfect drink. Very few people will be able to know that their ideal drink is “234 grams of 1.3% milkfat milk, 94 grams of white chocolate powder, 70 ml of espresso”, etc. Instead, people will know a general recipe that they like (e.g. a Non-Fat Mocha) and will be able to work from there, modifying it. To help them identify how they might like to modify this “off-the-shelf” recipe, the Tweaker shows the user the original recipe's ingredients, then offers some possible increase and decrease scenarios for each ingredient. In one example, the user wants to try 5% more espresso and 10% more White Chocolate than the original recipe. These “Tweaks” ultimately form a new drink which is then named. After trying it, the user may wish to try tweaking the new drink, or may wish to go back to the previous drink and try the tweaking process over.

12. “Optometrist”. Much like the optometrist runs you through a series of tests (“Better or Worse?”) to find your eye prescription, the system asks the customer some questions to try to hone in on his ideal drink. This is another variation on the Tweaker concept, the Optometrist attempts to use the approach of optometrists to hone in on a user's ideal drink. For those not familiar, an optometrist, in order to find a patient's best prescription, will choose a starting point and iteratively ask the patient to evaluate a prescription, changed a little at a time, as “better, or worse”. Over the course of a few iterations, the optometrist eventually reaches a conclusion about the best prescription by listening to the patient's assessment of “better, or worse” for different samples. While tastes do not necessarily have as clearly defined “prescription” as a glasses prescription, the principle can still apply. Using this logic, this Automated Coffee System version of the “Optometrist” takes a recipe that the user likes, and offers slight variants for assessment. If the existing favorite drink is “beaten” by (i.e. preferred to) a new drink, it becomes the new favorite against which to evaluate new variations. The screen above shows how slight variations are concocted, simple by adding or subtracting some amount (e.g. 5%) of one of the ingredients to see if the user enjoys the drink more or less with that change being made. Done iteratively, the user will likely come to a recipe over time that will not be beaten by variations, at which point the user's “ideal” drink has been identified and can be served up regularly for the user.

13. Dynamic pricing, multiple price lists. All customized drinks are dynamically (formulaically) priced, based on the ingredients and quantity. Different price lists are available for different locations, following the same pattern of formulaic pricing (example: a base cost of 30 cents plus 2 cents per milliliter volume for ingredient A, 3 cents per milliliter for ingredient B, etc.). The system allows for surcharges, if necessary (e.g. if gas prices are extremely high, or if certain locations require it).

14. Price increase threshold. For “quick order” drinks, the customer agrees to a price-increase threshold in advance. In other words, if a customer's drink is normally $2.85 and the customer agrees to a 15 cent threshold, the customer's order will automatically be filled if the price increases to $3.00 or if a different location has a different price list that brings the price to $3.00. Otherwise, the customer will be required to accept the increase through the web application or through a phone prompt.

15. Let others order drinks for you (e.g. secretaries, friends). It is common for people to ask others to get food/drinks for them. Often people will get the drinks wrong, so we will allow for the ability to “share” the drink recipe so that a secretary, for example, can get drinks for all people attending a meeting, and get each person their favorite drink without errors.

16. Multi-lingual. The web site is available in a few key languages.

17. Duplicate receipts available online to print for those who might need to expense their purchase.

### VI. the Phone Application (IVR—Interactive Voice Response)

The system according to the present invention may further include an application which enables the users to quickly converge on one or two drinks that they order regularly and send to one or two locations. Once this occurs, most of the functionality of the web site will not be used. It is expected that once the user creates his perfect drink, he often wants to order their drink through the phone. A simple IVR system will accommodate for a few common scenarios. As examples: (1) “1-1-1” might mean “I want my favorite drink and my regular location on my most commonly used schedule”; (2) other combinations may allow them to search for the closest machine; and (3) more visual details about the order will always be available on the web site.

A key to the phone application will be using “caller ID’, for quickly identifying the calling customer by his/her phone number. In this way, the system would immediately know who is calling and what their likely request is (namely, their favorite drink at their favorite location or second-favorite location). This allows for a customer's needs to be satisfied 95% of the time with only a few options.

### VII. The Administrative Application

The system further includes an administrative application available for customer service representatives, management and the restock/repair groups. The application is used to (1) determines which machines are operating/broken; (2) shows inventory levels, creates refill requirements; (3) create marketing campaigns; (4) make credit accounts when necessary, and (5) make basic reporting of sales/margins and trends.

It is likely that much of the back-end (including the Administrative Application) could be based on an existing eCommerce platform, as much of the functionality would be consistent with that of other eCommerce sites. Some examples of functionality that are common with such platforms include:

1. Customer Information, such as (1) profiles for individuals and organizations and (2) organizational hierarchies and attribute inheritance.

2. Personalization—the system is able to personalize to organizations, roles, individuals, or custom-defined user segments, and to track and record information on customer segment, content categorization, and targeting rules managers.

3. Customer Service, including customer self-service order status and history, self-service registration requests, self-service account administration, and customer service representative module.

4. Marketing, such presenting information on campaigns (outbound e-mails, Web site offers, etc), campaign triggers (date, target user activity, threshold), and campaign results tracking.

5. Pricing—the system processes information on contract, product, SKU, or volume-based (bulk and tiered) pricing, and automatically calculates and presents custom price lists for specific accounts, regions, selling seasons, or any custom-defined segment.

6. Merchandising—the system may include various merchandising functions, including but not limited to cross-sell or up-sell related products (promotional up-sell), SKU bundles, configurable SKUs, flexible promotions/coupons (fixed, percent, one-time use, rules-based), search (keyword, parametric, refined), product comparisons, punch in from product configurators, gift list/wish list/purchase list, and gift certificates and couponing gift certificate and coupon claim codes.

7. Ordering—the system provides an approval workflow, a notification means for the event-based scenarios notifying the seller of saved order purchases. The system sets a number of order restrictions and other parameters for recurring/scheduled orders/purchase orders, as well as requisitions. The system also supports for multiple inventory systems.

8. Payments—the system incorporates means for fraud detection and credit card transaction processing.

The system and method described in this application is equivalently applicable in serving any food product which can be prepared by machine. Therefore, in this document, “drink” can be extended to any beverage or food which can be prepared by machines, such as mixed alcoholic drinks, coffee, tea, salads, burritos, etc. While one or more embodiments of the present invention have been illustrated above, the skilled artisan will appreciate that modifications and adoptions to those embodiments may be made without departing from the scope and spirit of the present invention.

1. A system for automated food and beverage service comprising:
a central server computer communicatively coupled to the Internet;
a central database associated with the central server;
a number of local server computers communicatively coupled to the central server computer through the Internet, each of which is associated with a machine for making a product according to commands from the local server computer;
at least one client computer communicatively coupled to the central server computer through the Internet;
a first software application running in the at least one client computer which enables a user to communicate with the central server computer through the Internet;
a second software application running in the central server computer which enables the central server computer to communicate with the client computer and with the local server computers through the Internet;
a third software application running in the local server computers which enables the local server computers to communicate with the central server computer through the Internet;
wherein the first software application provides a user interface through which the user may make a customized order by dragging various icons representing various ingredients to an icon representing a container using a mouse coupled to the client computer and submit the customized order to the central server via the Internet;
wherein the second software application processes the data received from the user and sends a product specification message to a local server computer designated by the user, the product specification message comprising a reference number associated with the user's customized order, recipe data and timing data; and
wherein the third software application transforms the product specification message received from the central server computer into commands for the machine to make a product according to the recipe data and the timing data for pick-up.

2. The system of claim 1, wherein the user interface further comprises:
means for dynamically showing in the container icon an ingredient icon when the ingredient icon is dragged to the container icon;
means for dynamically indicating names and amounts of ingredients represented by the ingredient icons added to the container icon;
means for limiting a maximal amount of an ingredient represented by the ingredient icon added to the container icon;
means for saving a recipe;
means for setting a pick-up location;
means for setting a pick-up timetable; and
means for indicating the user's history of orders and status of current order.

3. The system of claim 2, wherein the user interface further comprises:
means for dynamically indicating nutritional information on the content represented by the ingredient icons added to the container icon; and
means for warning on nutritional information or insolubility on the content represented by the ingredient icons added to the container icon.

4. The system of claim 2, wherein the user interface further comprises:
means for removing an ingredient icon from the container icon; and
means for changing amount of an ingredient represented by the ingredient icon added to the container icon.

5. The system of claim 2, wherein the user interface further comprises:
means for retrieving a saved recipe;
means for modifying a retrieved recipe.

6. The system of claim 5, wherein the means for modifying a retrieved recipe further comprises a number of preset change scales in percentage, wherein the user makes a change by selecting an ingredient and selecting one of the preset change scales.

7. The system of claim 2, wherein the user interface further comprises:
means for sharing a recipe with others; and
means for a user to post messages which can be read by other users.

8. The system of claim 1, further comprising:
means for the user to place an order through telephone by entering a piece of information associated with a saved recipe in the central computer; and
means for the user to place an order in person at the machine by entering a piece of information associated with a saved recipe in the central computer.

9. The system of claim 1, further comprising:
means for notifying the user when the product is ready for pick-up.

10. The system of claim 9, the means for notifying is any of:
an automatic telephone message sent to the user's telephone;
a textual message sent to the user's mobile phone; and
an e-mail sent to the user's computer or/and web-enabled mobile phone.

11. A method for providing automated food and beverage service through the Internet, comprising the steps of:
(a) providing a central server computer communicatively coupled to the Internet, the central server being associated with a central database;
(b) providing a number of local server computers communicatively coupled to the central server computer through the Internet, each of which is associated with a machine for making a product according to commands from the local server computer;
(c) at least one client computer communicatively coupled to the central server computer through the Internet;
(d) providing a first software application which enables a user to communicate with the central server computer through the Internet, the first software application comprises a user interface through which the user makes a customized order by dragging various icons representing various ingredients to an icon representing a container using a mouse coupled to the client computer and submit the customized order to the central server via the Internet;
(e) providing a second software application which enables the central server computer to communicate with the client computer and with the local server computers through the Internet, the second software application processing the data received from the user and sending a product specification message to a local server computer designated by the user, the product specification message comprising a reference number associated with the user's customized order, recipe data and timing data; and
(f) providing a third software application which enables the local server computers to communicate with the central server computer through the Internet, the third software application transforming the product specification message received from the central server computer into commands for the machine to make a product according to the recipe data and the timing data for pick-up.

12. The method of claim 11, wherein the step (d) comprises the steps of:
providing a means for dynamically showing in the container icon an ingredient icon when the ingredient icon is dragged to the container icon;
providing a means for dynamically indicating names and amounts of ingredients represented by the ingredient icons added to the container icon;
providing a means for limiting a maximal amount of an ingredient represented by the ingredient icon added to the container icon;
providing a means for saving a recipe;
providing a means for setting a pick-up location;
providing a means for setting a pick-up timetable; and
providing a means for indicating the user's history of orders and status of current order.

13. The method of claim 12, further comprising the steps of:
dynamically indicating nutritional information on the content represented by the by the ingredient icons added to the container icon; and
showing pop-up message to warn the user of potentially undesirable nutritional information on the content represented by the ingredient icons added to the container icon.

14. The method of claim 12, further comprising the steps of:
providing a means for removing an ingredient icon from the container icon by dragging it away from the container icon;
providing a means for removing an ingredient icon from the container icon by deleting the ingredient represented by the ingredient icon from a pulling-down list, and
providing a means for changing amount of an ingredient represented by the ingredient icon added to the container icon by right-clicking the ingredient icon and selecting from a list of preset amounts.

15. The method of claim 12, further comprising the steps of:
providing a means for retrieving a saved recipe by selecting one from a pulling-down list of saved recipe;
providing a means for modifying a retrieved recipe to make a new recipe.

16. The method of claim 15, wherein the step of modifying a retrieved recipe further comprises steps of:
clicking an ingredient icon in the container icon; and
selecting an amount for the ingredient from a list of preset change scales in percentage.

17. The method of claim 12, further comprising the steps of:
sharing a recipe with others by triggering an automatic e-mail to one or more e-mail addresses; and
providing a means for the user to post messages which can be read by other users through the user interface.

18. The method of claim 11, further comprising:
providing a means to enable the user to place an order through telephone by entering a piece of information associated with a saved recipe in the central computer; and
providing a means to enable the user to place an order in person at the machine by entering a piece of information associated with a saved recipe in the central computer.

19. The method of claim 11, further comprising the step of:
notifying the user when the product is ready for pick-up.

20. The method of claim 19, the step of notifying comprises any of:
sending an automatic telephone message to the user's telephone;
sending a textual message to the user's mobile phone; and
sending an e-mail to the user's computer or/and web-enabled mobile phone.
